(19) United States
(12) Patent Application Publication
(10) Pub. No.: US 2013/0300131 A1
(43) Pub. Date: Nov. 14, 2013

(54) METHOD OF OPERATING VARIABLE FLUX ELECTRIC STARTER MACHINE HAVING DUAL FIELDS

(71) Applicant: REMY TECHNOLOGIES, L.L.C., Pendleton, IN (US)

(72) Inventor: Michael D. Bradfield, Anderson, IN (US)

(73) Assignee: REMY TECHNOLOGIES, L.L.C., Pendleton, IN (US)

(21) Appl. No.: 13/672,219

(22) Filed: Nov. 8, 2012

Related U.S. Application Data
(62) Division of application No. 13/481,024, filed on May 25, 2012, now abandoned.
Application No. 13/481,024 is a continuation of application No. 13/466,525, filed on May 8, 2012.

(51) Int. Cl. F02N 11/08; H02P 1/04

(52) U.S. Cl. 290/38 R; 318/493

(57) ABSTRACT

A method of operating a variable flux electric machine includes passing an electrical current through a plurality of wound poles of a wound field to generate a first flux, rotating an armature at a first crank point having a first speed in response to the first flux, shorting at least one of the plurality of wound poles, generating a second flux through a permanent magnet (PM) field having a plurality of PM poles, and rotating the armature at a second crank point having a second speed in response to the second flux, the second speed being greater than the first speed.

### CROSS REFERENCE TO RELATED APPLICATIONS

This application is a Divisional Application of U.S. application Ser. No. 13/481,024 filed May 25, 2012 which claims priority to U.S. application Ser. No. 13/466,525 filed May 8, 2012, the disclosure of which is incorporated by reference herein in its entirety.

### BACKGROUND OF THE INVENTION

Exemplary embodiments pertain to the art of electric machines and, more particularly to a variable flux electric machine having dual fields.

Electric machines are employed in a wide range of applications. For example, vehicles that employ internal combustion engines generally include an electric machine in the form of a starter motor. The starter motor is selectively activated to initiate operation of the internal combustion engine. The electric starter motor includes an armature that rotates in response to a magnetic motive force established between armature windings and a stationary field. The armature is coupled to a pinion gear that is configured to engage with a ring gear on the internal combustion engine. A solenoid drives the pinion gear into the ring gear to start the internal combustion engine.

### BRIEF DESCRIPTION OF THE INVENTION

Disclosed is a method of operating a variable flux electric machine. The method includes passing an electrical current through a plurality of wound poles of a wound field to generate a first flux, rotating an armature at a first crank point having a first speed in response to the first flux, shorting at least one of the plurality of wound poles, generating a second flux through a permanent magnet (PM) field having a plurality of PM poles, and rotating the armature at a second crank point having a second speed in response to the second flux, the second speed being greater than the first speed.

Also disclosed is a method of operating a variable flux electric machine. The method includes rotating an armature at a first speed in response to a first flux provided by a plurality of wound poles, and rotating the armature at a second speed in response to a second flux provided by a permanent magnet (PM) field, the second speed being greater than the first speed.

### BRIEF DESCRIPTION OF THE DRAWINGS

The following descriptions should not be considered limiting in any way. With reference to the accompanying drawings, like elements are numbered alike:

FIG. 1 depicts a partial cross-sectional side view of a variable flux electric starter motor in accordance with an exemplary embodiment;

FIG. 2 depicts a partial cross-sectional end view of the variable flux electric starter motor of FIG. 1;

FIG. 3 depicts a Torque-Speed (T-S) Graph illustrating T-S curves for a wound field, a permanent magnet (PM) field, and a shunted PM field;

FIG. 4 depicts a schematic diagram illustrating an electrical connection of first and second wound poles of the variable flux electric starter motor of FIG. 1; and

FIG. 5 depicts a block diagram illustrating electrical connections of first and second wound poles of the variable flux electric starter motor of FIG. 1.

### DETAILED DESCRIPTION OF THE INVENTION

A detailed description of one or more embodiments of the disclosed apparatus and method are presented herein by way of exemplification and not limitation with reference to the Figures.

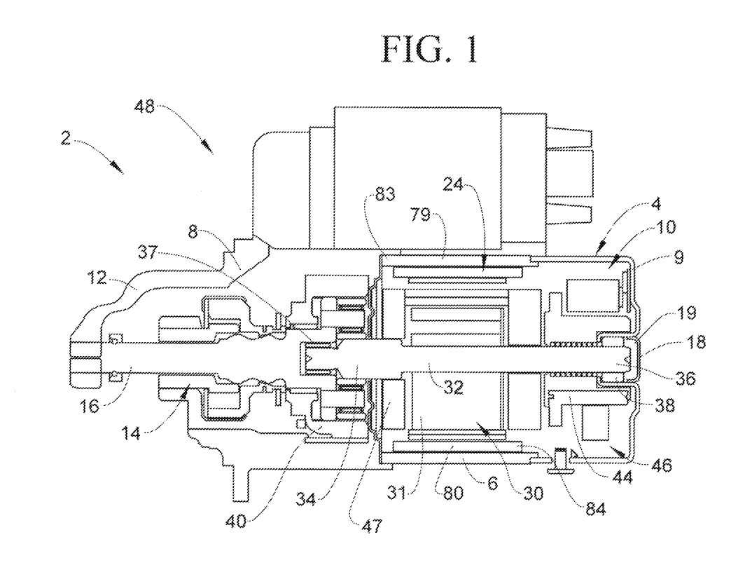

A variable flux electric starter motor in accordance with an exemplary embodiment is indicated generally at 2 in FIG. 1. Starter motor 2 includes a frame 4 having an outer wall 6. Outer wall 6 includes a first end 8 that extends to a second end 9. Outer wall 6 defines an interior portion 10. In the exemplary aspect shown, starter motor 2 includes a pinion housing 12 arranged at first end 8. Pinion housing 12 surrounds, in part, a pinion gear 14 rotatably mounted to a pinion gear shaft 16. An end plate 18 is mounted at second end 9. End plate 18 includes a recessed portion 19. Starter motor 2 is also shown to include a field assembly 24 mounted to an inner surface (not separately labeled) of outer wall 6 and a rotor or armature assembly 30.

Armature assembly 30 includes an armature core 31 supported upon an armature shaft 32. Armature core 31 is spaced from field assembly 24 by an air gap (not separately labeled). Armature shaft 32 includes a first end portion 34 that extends to a second end portion 36. First end portion 34 is supported by a bearing 37 provided within a recess (not separately labeled) of pinion gear shaft 16 while second end portion 36 is supported by a bearing 38 arranged within recessed portion 19. First end portion 34 of armature shaft 32 is operably coupled to pinion gear 14 through a gear assembly 40. Armature assembly 30 is also shown to include a commutator 44 that is coupled to a brush assembly 46, thus starter motor 2 is a brushed direct current (DC) starter. Brush assembly 46 delivers electrical current to armature windings 47 through commutator 44. The electrical current flowing through armature windings 47 interact with field assembly 24 to set up a magnetic motive force (MMF). The MMF sets up a flux within the air gap between armature core 31 and field assembly 24. The flux interacts with current flowing through armature core 31 causing armature assembly 30 to rotate within frame 4. The rotation of armature assembly 30 is translated to pinion gear 14 through gear assembly 40. A solenoid 48 shifts pinion gear 14 along pinion gear shaft 16 into engagement with a ring gear (not shown) that is typically provided on a fly wheel (also not shown) of a motor 2.

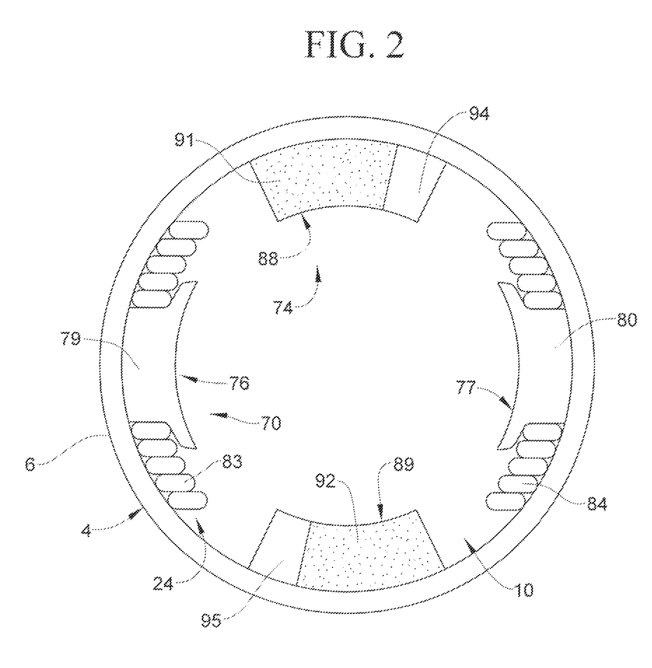

In accordance with an exemplary embodiment, field assembly 24 includes a first or wound field 70 and a second or permanent magnet (PM) field 74 as shown in FIG. 2. In this manner, starter motor 2 includes a selectively activated mixed field having properties derived from wound field 70 or from PM field 74. Wound field 70 includes a first wound pole 76 and a second wound pole 77. First wound pole 76 includes a first pole shoe 79 mounted to an inner surface (not separately labeled) of outer wall 6. Similarly, second wound pole 77 includes a second pole shoe 80 mounted to the inner surface (also not separately labeled) of outer wall 6 substantially directly opposite to first pole shoe 79. A first plurality of windings 83 is provided at first pole shoe 79 and a second plurality of windings 84 is provided at second pole shoe 80.

As shown in FIG. 4, first plurality of windings 83 is electrically connected in parallel with second plurality of windings 84. As will be discussed more fully below, first and second wound poles 76 and 77 are configured to produce a first flux when starter motor 2 is operated. PM field 74 includes first and second permanent magnets 88 and 89 mounted to the inner surface (not separately labeled) of outer wall 6. First permanent magnet 88 is positioned generally opposite to second permanent magnet 89. First permanent magnet 88 defines a first PM pole 91 and second permanent magnet defines a second PM pole 92. First and second PM poles 91 and 92 are configured to establish a second flux when starter motor 2 is operated. A first shunt 94 is positioned adjacent to first PM pole 91 and a second shunt 95 is positioned adjacent second PM pole 92. First and second shunts 94 and 95 condition the second flux established by PM field 74.

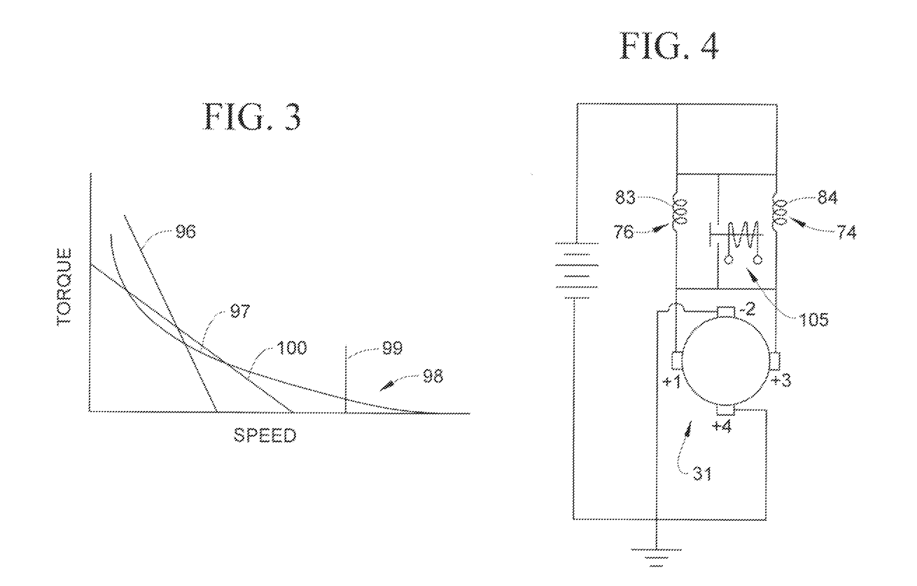

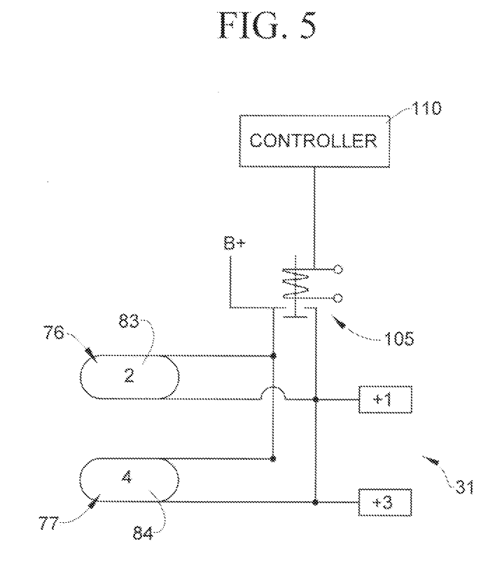

Wound field 70 produces a generally curvilinear Torque-Speed (T-S) curve such as shown at 97 in FIG. 3. PM field 74 is known to produce a generally linear curve. T-S curve 97 includes a sweeping tail portion 98 that extends beyond a design speed threshold 99 for starter motor 2. In accordance with an exemplary embodiment, wound field 70 cooperates with PM field 74 to eliminate sweeping tail portion 98 and produce a more linearized T-S curve 96. In this manner, PM field 74 more closely matches an upper portion of T-S curve 97 produced by wound field 70. As will be discussed more fully below, PM field 74 is selectively enabled to overcome wound field 70 to allow pinion gear 14 to rotate at a higher crank point than would be produced if powered by wound field 70. With this arrangement, PM field 74 produces a T-S curve such as shown at 100.

In further accordance with an exemplary embodiment, a relay 105 is coupled across first and second windings 83 and 84. A controller 110 is coupled to, and selectively activates, relay 105 to operate starter motor 2 at higher crank points. Controller 110 generally takes the form of an electronic control unit (ECU) provided in a motor vehicle. However, it should be understood, that controller 110 can take on a variety of forms. At this point it should be understood that relay 105 may be mounted remotely from starter motor 2 or, alternatively may be arranged within or mounted to frame 4 or integrated into solenoid 48. The particular starter motor described herein is configured to be employed in connection with start/stop operations. More specifically, in addition to traditional use of starting a cold motor, starter motor 2 may be employed to start a warm motor such as following motor shut down at a traffic light, while an electric motor is in use, and the like.

During cold starts, higher pinion torque and lower pinion speeds are desirable. The higher pinion torque is generally more adept at turning over a cold motor. Accordingly, during cold start situations relay 105 is open thereby enabling electrical current to flow through windings 83 and 84 to produce the first flux (not separately labeled) that establishes a first crank point 110. In this manner, wound field 70 may be designed to produce a cold crank target that possesses relatively high torque at relatively lower speeds. It should be understood that PM field 74 also contributes to the first flux but is dominated by wound field 70 during cold start situations.

During warm starts, when it is desirable to start the motor in a short time period, controller 110 activates relay 105 to cause windings 83 and 84 to be shorted. At this point it should be understood that while being shorted, some current will continue to flow. The amount of current flow is determined by resistance of relay 105 and resistance of windings 83 and 84. In this manner, PM field 74 dominates wound field 70 to produce a second flux that achieves a warm crank target that has a second crank point 120 having lower torque and higher speeds than the cold crank target (FIG. 3). The particular cold crank target and warm crank target can vary depending on the particular vehicle, operating conditions, environmental conditions and the like. The PM field 74, coupled with shunts 94 and 95 provides the desired higher pinion speeds that lead to quicker motor starting without exceeding a maximum pinion speed of the starter motor 2.

The exemplary embodiments provide a single starter motor that produces variable flux achieved through a selective application of mixed fields. That is, the starter motor possesses both the operational characteristics of a wound field and a PM field. The particular field active at any one time depends on the desired starting conditions as determined by, for example controller. It should also be understood that while shown and described as a four pole configuration, the number of poles in the starter motor may vary. For example, the exemplary embodiments may be incorporated into a starter motor having as few as two poles or as many as eight or more poles.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

1. A method of operating a variable flux electric machine, the method comprising:
passing an electrical current through a plurality of wound poles of a wound field to generate a first flux;
rotating an armature at a first crank point having a first speed in response to the first flux;
shorting at least one of the plurality of wound poles;
generating a second flux through a permanent magnet (PM) field having a plurality of PM poles; and
rotating the armature at a second crank point in response to the second flux, the second crank point having a second speed that is greater than the first speed.

2. The method of claim 1, further comprising: shunting the PM field.

3. The method of claim 1, wherein passing the electrical current through a plurality of wound poles of a wound field includes passing the electrical current through a first wound pole electrically coupled in parallel to a second wound pole.

4. The method of claim 1, wherein passing the electrical current through a plurality of wound poles of a wound field includes passing the electrical current to an armature of a brushed direct current (DC) electric motor.

5. The method of claim 1, wherein shorting the at least one of the plurality of wound poles includes shorting two of the plurality of wound poles.

6. The method of claim 5, wherein shorting the two of the plurality of wound poles includes closing a relay electrically connected between the two of the plurality of wound poles.

7. The method of claim 1, wherein shorting the at least one of the plurality of wound poles causes the armature to rotate in response to the second flux provided primarily from the plurality of PM poles.

8. The method of claim 1, wherein the first flux is provided primarily from the plurality of wound poles.

9. The method of claim 1, wherein rotating the armature at the first speed includes rotating the armature with a first torque and rotating the armature at the second speed includes rotating the armature with a second torque, the first torque being greater than the second torque.

10. The method of claim 1, wherein rotating the armature at the first speed is performed during a cold start condition.

11. The method of claim 1, wherein rotating the armature at the second speed is performed during a warm start condition.

12. A method of operating a variable flux electric machine, the method comprising:
rotating an armature at a first speed in response to a first flux provided by a plurality of wound poles;
shorting at least one of the plurality of wound poles; and
rotating the armature at a second speed in response to a second flux provided by a permanent magnet (PM) field, the second speed being greater than the first speed.

13. (canceled)

14. The method of claim 12, further comprising: shunting the PM field.

15. The method of claim 12, wherein rotating the armature at the first speed includes passing electrical current through the plurality of wound poles including a first wound pole electrically coupled in parallel to a second wound pole.

16. The method of claim 15, wherein rotating the armature at the second speed includes shorting at least one of the plurality of wound poles.

17. The method of claim 16, wherein shorting at least one of the plurality of wound poles includes shorting the first wound pole and the second would pole.

18. The method of claim 12, wherein the first flux is provided primarily from the wound poles.

19. The method of claim 12, wherein rotating the armature at the first speed includes rotating the armature with a first torque and rotating the armature at the second speed includes rotating the armature with a second torque, the first torque being greater than the second torque.

20. The method of claim 12, wherein rotating the armature at the first speed is performed during a cold start condition and rotating the armature at the second speed is performed during a warm start condition.
